(19) United States
(12) Patent Application Publication
(10) Pub. No.: US 2011/0199191 A1
(43) Pub. Date: Aug. 18, 2011

(54) RECONFIGURATION OF A RADIO FREQUENCY READER

(76) Inventor: Mark Alan Buckner, Oak Ridge, TN (US)

(21) Appl. No.: 12/705,119

(22) Filed: Feb. 12, 2010

(51) Int. Cl. H04Q 5/22

(52) U.S. Cl. 340/10.51

(57) ABSTRACT

A radio frequency (RF) reader, comprising a memory; and a processor in communication with the memory, the memory including computer code executable with the processor. The computer code is configured to: determine a first communication characteristic for a first device coupled with the RF reader, the first device being operable to communicate with the RF tag using the first communication characteristic; determine a first reader configuration that is operable to communicate using the first communication characteristic; determine a second communication characteristic for a second device coupled with the RF reader, the second device being operable to communicate with the RF tag using the second communication characteristic; determine a second reader configuration that is operable to communicate using the second communication characteristic; and switch a RF reader configuration between the first reader configuration and the second reader configuration, such that the RF reader is operable to communicate with the first device and the second device.

### FEDERALLY SPONSORED RESEARCH OR DEVELOPMENT

This invention was made with government support under Contract No. DE-AC05-00OR22725 awarded by the U.S. Department of Energy. The government has certain rights in the invention.

### BACKGROUND

A radio frequency (RF) reader communicates with a RF device, such as a RF tag, other RF reader, or RF radio. Communication includes transmitting and/or receiving an RF signal. The RF tag is configured to communicate using defined communication characteristics, such as a defined frequency, a defined waveform, and/or one or more defined protocols. The RF reader is operable to communicate with a RF device that is configured to communicate using the same communication characteristics as the RF reader. However, the RF reader is unable to communicate with an RF device, which is not configured to communicate using the RF reader's communication characteristics. For example, a RF tag in the United States may be configured to communicate at 433 megahertz (MHz); however, a RF tag in Europe may be configured to communicate at 915 MHz. A RF reader configured to communicate with a United States RF tag is unable to communicate with a European RF tag since the European RF tag does not communicate at the same frequency as the United States RF tag.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates one embodiment of a system for communication.

FIG. 2 illustrates one embodiment of a RF reader.

FIG. 3 illustrates another embodiment of a system for communication.

FIG. 4 illustrates another embodiment of a RF reader.

FIG. 5 illustrates one embodiment of a communication characteristic determination.

FIG. 6 illustrates another embodiment of communication characteristic determination.

FIG. 7 illustrates another embodiment of a RF reader.

FIG. 8 illustrates one embodiment of a method for transmitting an RF signal.

FIG. 9 illustrates one embodiment of determining context information.

### DETAILED DESCRIPTION

A radio frequency (RF) reader may be dynamically configured or reconfigured to communicate with one or more RF devices and/or one or more communication devices. The RF devices and/or communication devices may use the same or different communication characteristics as each other or the RF reader. Herein, “configured” and “reconfigured” relate to the adjustment of hardware, software, firmware, documentation, or any combination thereof that performs a specific act, such as communicating at a defined RF or using a defined protocol. Herein, “communication characteristics” include or define zero, one, or more of the following: a signal property (e.g., frequency, wavelength), waveform, a communication standard (e.g., protocols, a stack of protocols), a RF device requirement (e.g., the location of a RF reader with respect to a RF tag), an authentication requirement (e.g., password, encryption), a geographical requirement (e.g., environment-specific requirement, location-specific requirements), a user-defined requirement (e.g., user-defined rules), any combination thereof, or any now known or later developed characteristic relating to communicating an RF signal. For example, configuration and/or reconfiguration may include reader/gateway functions, modulation, shaping, error-correction coding, and symbol encoding. The communication characteristics define the requirements for communicating with a device, such as the RF tag 20 or RF device 30.

By way of introduction, the embodiments described below include systems and methods for configuring an RF tag. In one method, a method for configuring a radio frequency (RF) reader is provided. The method includes configuring the RF reader to communicate with a first RF tag coupled with the RF reader, the RF tag using a first communication characteristic to communicate with the RF reader; receiving a first communication signal from the RF tag, the first communication signal being transmitted using a first communication characteristic, the first communication signal including RF tag information; configuring the RF reader to communicate with a first communication device coupled with the RF reader, the first communication device using a second communication characteristic to communicate with the RF reader; transmitting the RF tag information to the first communication device using the second communication characteristic.

In one system, a radio frequency (RF) reader is provided. The RF reader includes a memory and a processor in communication with the memory. The memory may include computer code executable with the processor. The computer code may be configured to determine a first communication characteristic for a first device coupled with the RF reader, the first device being operable to communicate with the RF tag using the first communication characteristic; determine a first reader configuration that is operable to communicate using the first communication characteristic; determine a second communication characteristic for a second device coupled with the RF reader, the second device being operable to communicate with the RF tag using the second communication characteristic; determine a second reader configuration that is operable to communicate using the second communication characteristic; and switch a RF reader configuration between the first reader configuration and the second reader configuration, such that the RF reader is operable to communicate with the first device and the second device. The first device and second device may communicate with the same or different communication characteristics. For example, in one embodiment, the first and second devices may communicate using the ISO 18000-7 & ANSI/INCITS 256 standards, which use the same frequency (e.g., 433 MHz). In another example, the first and second devices may communicate using the ISO 18000-4 & ISO 18000-7 standards, which use different frequencies (e.g., 2.45 GHz/433 MHz)

In another system, logic encoded in one or more tangible media for execution is provided. When executed, the logic is operable to cause a RF reader to determine a first reader configuration for the RF reader, such that the RF reader is operable to communicate with a first RF tag; determine a second reader configuration for the RF reader, such that the RF reader is operable to communicate with a second RF tag; select a first reader configuration or a second reader configuration; and configure the RF reader using the selected first reader configuration or selected second reader configuration.

In one illustration, which is referred to herein as “the above illustration,” a configurable RF reader according to the disclosed embodiments is placed above and/or around a railroad track. The RF reader communicates with RF tags placed in, on, or around vehicles traveling on the highway and with police department radios. The RF reader includes or communicates with a radar device that detects the speed of passing vehicles. A first vehicle, such a sports car, which has a first RF tag, travels past the configurable RF reader. The sports car has a first RF tag that communicates with the configurable RF reader at 433 MHz and using a passenger protocol, such as EasyPass or I-Pass or other toll systems. A second vehicle, such as a cargo truck, travels past the configurable RF reader. The cargo truck has a second RF tag that communicates with the configurable RF reader at 915 MHz and using a shipment protocol. The RF reader may be dynamically configured to communicate with the first and second RF tags, such that the RF reader is operable to communicate with both the first RF tag and the second RF tag. The RF reader may also be configured to transmit information, such as the speed of a vehicle, to the police department radio, another radio device, or a communication device.

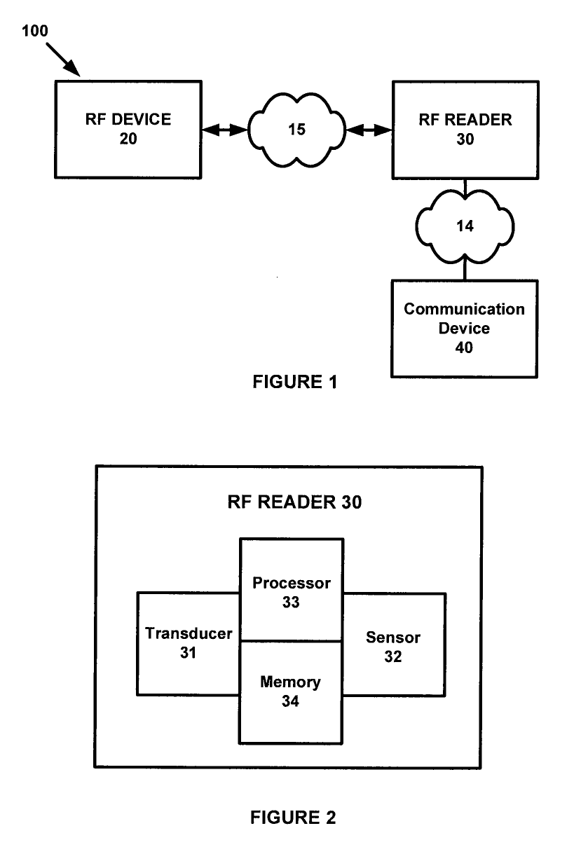

FIG. 1 shows one embodiment of a system 100 for RF communication. The system 100 includes an RF device 20, an RF reader 30, and a communication device 40. The RF device 20 may be continuously or periodically coupled with the RF reader 30 through the network 15. The RF reader 30 may be continuously or periodically coupled with the communication device 40 through the network 14. Herein, the phrase “coupled with” includes directly connected to or indirectly connected through one or more intermediate components. Such intermediate components may include both hardware and software based components. In alternative embodiments, additional, different, or fewer components may be provided.

The system 100 is a communication system, radio system, an RF identification (RFID) system, a supply-chain system, a security system, a configuration system, a detection system, a relay system, or any combination thereof. The system 100 may be used to configure or reconfigure the RF reader 30 to communicate using one or more communication characteristics. The RF reader 30 may be dynamically configured or reconfigured to communicate using different communication characteristics. As used herein, “dynamically” relates to switching, changing, altering, or adjusting one or more aspects of a configuration of the RF reader.

The networks 14, 15 are communication networks, RF networks, Internet Protocol (IP)/Transfer Control Protocol (TCP) networks, cellular network, or satellite communication network, wireless networks, wired networks, other now known or later developed network, or a combination thereof, for providing communication. For example, the network 15 includes an RF network, and the network 14 includes an IP/TCP network. The networks 14, 15 are used to transmit and receive information, such as signals or messages. The signals may include data, biometric data, or telemetric data. The networks 14, 15 may be defined networks, such as protocol defined networks.

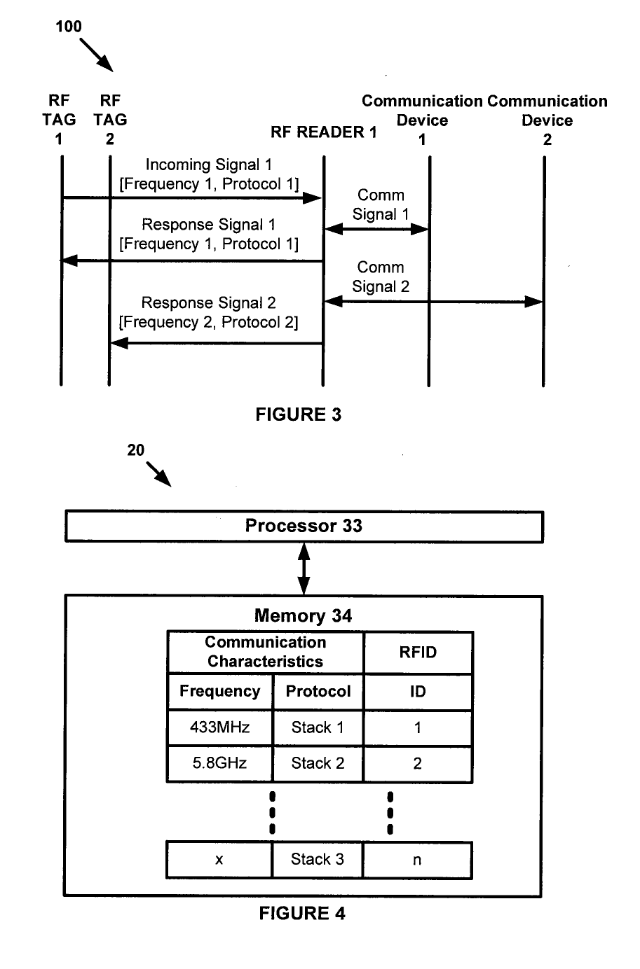

FIG. 1 illustrates a system 100 with a single RF device 20, a single RF reader 30, and a single communication device 40. However, in alternative embodiments, the system 100 may include one or more RF devices 20, one or more RF readers 30, one or more communication devices 40, or any combination thereof. For example, as shown in FIG. 3, in one embodiment, the system 100 includes a plurality of RF devices 20 and a plurality of communication devices 40.

The RF device 20 is an RF tag, another RF reader, an RF radio, or a RF communication device. The RF device 20 is operable to communicate with the RF reader 30 using the network 15. The RF device 20 may transmit an RF signal to or receive an RF signal from the RF reader 30.

In one embodiment, the RF device 30 is a configurable RF tag, as disclosed in U.S. Pat. No. ______, entitled “RECONFIGURATION OF A RADIO FREQUENCY TAG,” which was filed on ______ and which is hereby incorporated by reference.

The RF device 20 may be continuously or periodically coupled with a mobile or stationary object, such as a good, a human, an animal, a container, a product, a traceable object, a sign, a toll-booth, or other movable or immovable object, equipment, machinery, a machine-to-machine devices. The RF device 20 may be fixed or attached to the interior or exterior of the object or otherwise integrated therewith. In the illustration above, the first vehicle and the second vehicle are objects, and the first RF tag and second RF tag are RF devices 30. The first RF tag may be displayed in the windshield of the sports car, and the second RF tag may be displayed in the windshield of the cargo truck or container.

FIG. 2 shows one exemplary embodiment of an RF reader 30. The RF reader 30 includes a transducer 31, a sensor 32, a processor 33, and a memory 34. As discussed below, the processor 33 is coupled with and operable to communicate with the other components.

In alternative embodiments, the RF reader 30 may include additional, different, or fewer components. For example, an internal power supply source may be provided. In another example, a display device is provided. In one embodiment, the display device is a hybrid programmable display device, as disclosed in U.S. Pat. No. ______ entitled “HYBRID PROGRAMMABLE DISPLAY DEVICE,” which was filed on ______ and which is hereby incorporated by reference.

The transducer 31 is an electromagnetic transducer (e.g., antenna), an electrochemical transducer (e.g., pH probe), an electromechanical transducer (e.g., strain gauge), electroacoustic transducer (e.g., hydrophone, loudspeaker, microphone, geophone), photoelectric transducer (e.g., laser diode, light-emitting diode, photodiode), electrostatic transducer (e.g., electrometer), thermoelectric transducer (e.g., thermocouple, peltier cooler, thermistor), radioacoustic transducer (e.g., Geiger-Muller tube, radio receiver), light sensor, passive infrared, or any other now known or later developed transducer.

The transducer 31 converts one type of energy or physical attribute to another. For example, an antenna is operable to convert electromagnetic waves, such as waves operating in the RF range, into electric current. Furthermore, the antenna may convert electric current into electromagnetic waves.

In one embodiment, the transducer 31 may receive RF signals from and/or transmit RF signals to the RF device 20. An RF signal may be a request signal (e.g., requesting an RFID or a system 10 attribute), a response signal (e.g., providing an RFID or a system 10 attribute in response to a request signal), or an informative signal (e.g., update information, RFID information, or a system 10 attribute). An informative signal may be transmitted in response to, or independently of, a request signal or response signal. For example, the RF reader 30 may transmit a communication update to the RF device 20. The communication update may include updated/changed communication characteristics, such as updated protocols. In the illustration above, the RF reader 30 may request an RFID from the first RF tag, which is registered to the owner of the sports car. The RFID may identify the owner of the sports car. The first RF tag may transmit the RFID to the RF reader 30.

The transducer 31 may receive communication signals from and/or transmit communication signals to the communication device 40. The communication signals may be communicated through network 14. The communication signals may be wireless signals, wired signals, satellite signals, radio signals, or other signals for communication. The communication signals may include system information, such as update information, RFID information, or other signals. The system information may be intended for the RF device 20, RF reader 30, communication device 40, or any combination thereof. For example, the RF reader 30 may receive a protocol update from the communication device 40, a network operations center, an in transit visibility server, or other authorized location device. The protocol update may be transmitted to the RF device 20.

As used herein, “transducer information” relates to information, which is received or transmitted using the transducer 31. For example, the transducer 31 may detect an incoming RF signal. The incoming RF signal may be used as transducer information.

In one embodiment, the transducer 31 is configurable or reconfigurable to communicate using communication characteristics. Configuration may be, at least in part, implemented using hardware. For example, the length of the transducer 31 may be lengthened to communicate using a first radio frequency. The effective electrical or physical length of the transducer 31 may be shortened to communicate with a second radio frequency. In an alternative embodiment, the transducer 31 includes fixed and static hardware.

The transducer 31 may operate with or without instruction from the processor 33 or other processing unit. For example, an incoming signal may induce electrical current in the transducer 31. The electrical current may be used to power-on the processor 33 or other processing unit. In another example, an internal power supply source is provided. The internal power supply source may provide the transducer 31 with power to periodically or continuously detect incoming signals at a defined time or location, such as once a minute, twice an hour, or three times in each state.

The sensor 32 is a smart sensor, thermal sensor, electromagnetic sensor, mechanical sensor, pressure sensor, location sensor, chemical sensor, optical radiation sensor, acoustic sensor, ionizing radiation sensor, transducer (as discussed above), communication device, a sensor based on Micro-Electro-Mechanical Systems (MEMS), nano-science sensor, nano-bio-electrical material sensor, or other now known or later developed sensor. The sensor may be an analog or digital sensor. The sensor output may be analog or digital.

The sensor 32 is a device that senses or detects a system attribute. Sensing may include measuring, detecting, or identifying. The system attribute may be a quality, a characteristic, a location, a physical property, or communication. For example, the sensor 32 may measure temperature, humidity, pressure, velocity, acceleration, location, shock, chemical levels, biological levels, radiological levels, nuclear levels. In another example, the sensor 32 detects video, audio, ultrasound, or light (e.g., infrared or near-infrared). In yet another example, the sensor 32 is a location sensor, such as a Global Positioning System (GPS) receiver, that is used to locate the position of the RF reader 30. In the illustration above, the radar device is a sensor 32. The radar device is used to determine the speed of passing vehicles, such as the sports car and the cargo truck.

FIG. 2 shows an RF reader 30 with a single transducer 31 and a single sensor 32. However, in one or more alternative embodiments, the RF reader 30 may include and/or communicate with one or more transducers 31 and/or one or more sensors 32. For example, in one embodiment, the RF reader 30 includes or communicates with a plurality of sensors 32, such as a radar device and a global positioning receiver.

The processor 21 is a general processor, a hybrid programmable processor, a digital signal processor, Multi-core such as Coherant Logix′ HyperX, application specific integrated circuit, field programmable gate array, analog circuit, digital circuit, field-programmable neural arrays, field programmable analog arrays, extended analog computers, neuromorphic circuits, combinations thereof, or other now known or later developed processor. The processor 31 may be a single device or a combination of devices, such as associated with a network or distributed processing. Any of various processing strategies may be used, such as multi-processing, multi-tasking, parallel processing, remote processing or the like. The processor 33 is responsive to instructions stored as part of software, hardware, integrated circuits, firmware, micro-code or the like. For example, the processor 21 is operable to execute instructions stored in memory 34.

For more detailed information regarding a hybrid programmable processor, please refer to U.S. Pat. No. ______, entitled “HYBRID PROGRAMMABLE PROCESSOR,” which was filed on ______ and which is hereby incorporated by reference.

The processor 33 is operable to communicate with and control the transducer 31, sensor 32, the memory 34, or any combination thereof. Communication may include transmitting or receiving signals. The signals may be transmitted across a network, such as a wire, a circuit, a wireless network, or any other communication network. For example, the processor 33 is operable to request sensor information from the sensor 32 and instruct the transducer 31 to transmit the sensor information to the communication device 40. In another example, the processor 33 is operable to read from or write to the memory 24.

As discussed above, communication characteristics may include zero, one, or more of the following: a signal property (e.g., frequency, wavelength), a communication standard (e.g., protocols, a stack of protocols), a RF device requirement (e.g., the location of a RF reader with respect to a RF tag), an authentication requirement (e.g., password, encryption), a geographical requirement (e.g., environment-specific requirement, location-specific requirements), a user-defined requirement (e.g., user-defined rules), any combination thereof, or any now known or later developed characteristic relating to communicating an electromagnetic or RF signal.

Table 1 illustrates exemplary communication standards.

TABLE 1
Communication Characteristics

| Description | Communication Standards |
|---|---|
| Parameters for air interface | ISO/IEC 18000-3:2008 |
| communications below 135 kHz | |
| Radio frequency identification for | ISO/IEC 18000-1:2008 |
| item management | |
| Radio frequency identification for | ISO/IEC 18000-2:2004 |
| item management | |
| Parameters for air interface | ISO/IEC 18000-4:2008 |
| communications at 13.56 MHz | |
| Parameters for air interface | ISO/IEC 18000-6:2004 |
| communications at 2.45 GHz | |
| Parameters for air interface | ISO/IEC 18000-7:2008 |
| communications at 860 MHz to 960 MHz | |
| Parameters for active air interface | ISO/TS 10891:2009 |
| communications at 433 MHz | |
| Freight | (1) EPCGlobal UHF Class 1 |
| Containers and | Gen 2 (860-930 MHz); |
| License Plate Standards | (2) HF Gen 2 (13.56 MHz); |
| | 802.11 (header based); |
| | (3) Ultra-wideband; |
| | (4) ZigBee (802.15.4) |

Communication characteristics are associated with one or more devices, such as the RF device 20, the RF reader 30, the communication device 40, or a combination thereof. The communication characteristics for a first device may be the same or different than the communication characteristics for a second device. For example, the communication characteristics for the RF device 20 may be different than the communication characteristics for the communication device 40. In another example, a plurality of RF devices 20 may have the same or different communication characteristics. Alternatively, or in addition to, a plurality of communication devices 40 may have the same or different communication characteristics.

In the illustration above, the first RF tag, which is disposed in or around the sports car, is associated with communication characteristics that define the first RF tag's operating frequency (e.g., 433 MHz) and communication protocol (e.g., a passenger protocol). The second RF tag, which may be disposed in or around the cargo truck, is associated with communication characteristics that define the second RF tag's operating frequency (e.g., 915 MHz) and communication protocol (e.g., an shipment protocol).

The processor 33 is operable to determine communication characteristics for the RF device 20, the communication device 40, or the combination thereof. Determining the communication characteristics may include signal processing, reading from memory (e.g., database), or other act, method, or process for recognizing or identifying communication characteristics. The processor 33 may determine the communication characteristics as a function of sensor information, transducer information, information received from the communication device, time, RFID information, location, an event, a trigger, a combination thereof, or other stimuli for determining communication characteristics. As used herein, “as a function” may be interrupted to mean “using,” “directly depending upon,” “indirectly depending upon,” “utilizing,” or “based upon.”

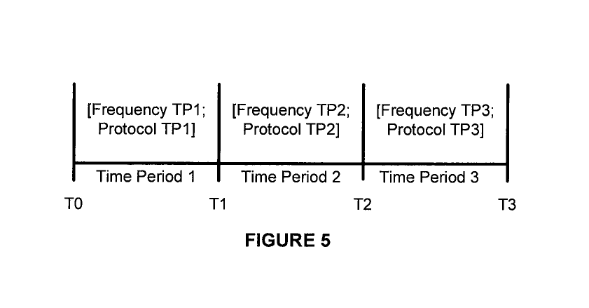

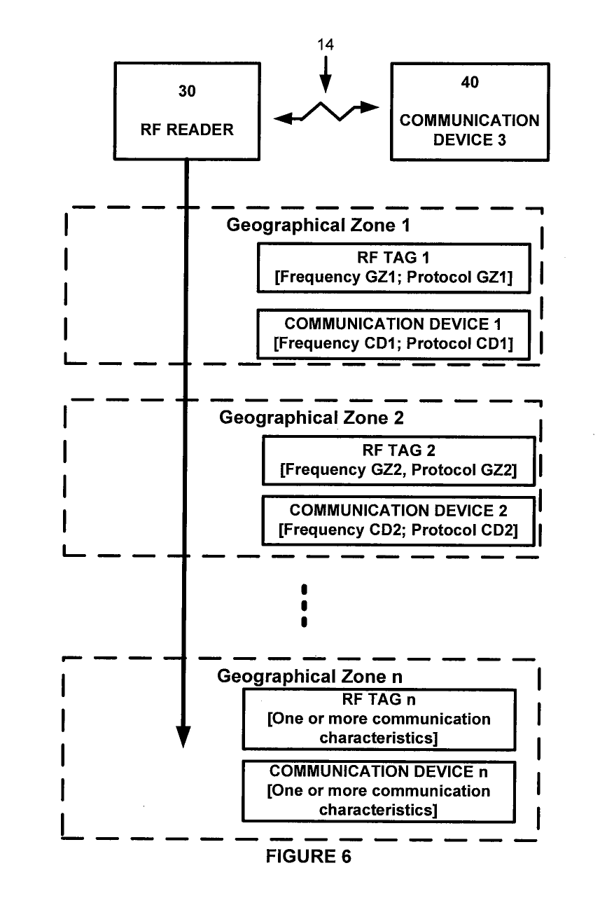

FIGS. 3-6 show examples of determining communication characteristics. More specifically, FIG. 3-4 illustrate examples of determining communication characteristics as a function of transducer information. FIGS. 5-6 illustrate examples of determining communication characteristics as a function of sensor information.

In the example of FIG. 3, the RF Reader 1 receives one or more incoming signals (e.g., Incoming Signal 1, Incoming Signal 2, Comm. Signal 1, Comm. Signal 2) from one or more RF Tags (e.g., RF Tag 1, RF Tag 2) and/or one or more communication devices (e.g., Communication Device 1, Communication Device 2). The Incoming Signal 1 is processed to determine RF Tag 1's communication characteristics. Processing includes signal processing. Accordingly, the RF Reader 1 determines that RF Tag 1 is communicating at Frequency 1 and using Protocol 1. In this example, Frequency 1 and Protocol 1 are the communication characteristics used to communicate with RF Tag 1. The RF Reader 1 may determine RF Tag 2's communication characteristics, Communication Device 1's communication characteristics, and Communication Device 2's communication characteristics. Alternatively, or in addition to, the Incoming Signal 1 may be transmitted to a communication device, such as Communication Device 1, for signal processing or determination of communication characteristics.

One benefit of determining communication characteristics as a function of an incoming signal is that the RF Reader 30 may dynamically communicate with one or more RF tags and/or one or more communication devices using only the communication between the RF Reader and the RF device and/or the communication device. In this example, configuring the RF Reader may not depend on location or other factors.

In one embodiment, communication characteristics are determined as a function of identification information, such as a received RF identification (RFID) or communication device identification. For example, the RF Reader 30 may transmit one or more request signals, which request an RFID, to an RF tag. The one or more request signals may be continuously or periodically transmitted. The request signals may be transmitted using a range of communication characteristic, such as a plurality of frequencies. Upon receiving a request and/or authenticated signal, the RF tag 20 may transmit a response signal, which includes the RF tag's RFID. As shown in FIG. 4, the processor 33 may read the memory 34 to determine the communication characteristics for the RF tag 20. For example, if the RF tag 20's RFID is “1,” then the communication characteristics for RF tag 20 are 433 MHz and Protocol Stack 1. Alternatively, or in addition to, the RF tag may transmit an RFID to the RF Reader 30, independently of a request signal. The RF reader 30 may receive the RFID.

In the example of FIG. 5, communication characteristics are determined as a function of time. The RF Reader 30 has a sensor 32, such as a timer, that determines the current time. The RF Reader determines whether the current time is in Time Period 1 (T0-T1), Time Period 2 (T1-T2), and/or Time Period 3 (T2-T3). As used herein, a “time period” is the period of time beginning at one time (e.g., T0) and ending at another time (e.g., T1). The period of time may or may not include the beginning and end time (e.g., T0 and T1). One or more time periods may be stored in a database (e.g., in the memory 34) and associated with communication characteristics. As shown in FIG. 4, Time Period 1 is associated with operating Frequency TP1 and Protocol TP1. Accordingly, Frequency TP1 and Protocol TP1 are used for communication during Time Period 1 (T0-T1). Alternatively, a past time or time period (e.g., a departure time, previous time period) or a future time or time period (e.g., estimated time of arrival, estimated length of a trip) may be used. In the illustration above, a first time period may 12:00 am to 7 am, a second time period may be 7:01 am to 7:00 pm, and a third time period may be 7:01 pm to 11:59 pm.

In alternative embodiments, time zones, travel time, speed, sensor levels that depend on time, and other time related values may be used to determine communication characteristics. By way of example, when a detected level is above a threshold level for a predefined time period, the processor 33 may use emergency communication characteristics, for example, an emergency frequency.

In one embodiment, the RF reader 30 may communicate with a network of RF readers. As used herein, a network of RF readers may include one, two, or more RF readers. The network of RF readers may be a web of RF readers or a mesh of RF readers. The communication may be used to transmit information. For example, in the illustration above, when the radar detector in the RF reader determines that the first vehicle is traveling above 100 mph, out of bounds, off-route or other geo-fencing feature the RF reader may communicate at an emergency frequency. Alternatively, or in addition to, the RF reader may communicate with one or more additional RF Readers. For example, a first RF reader may communicate that the first vehicle is traveling above 100 mph to a second RF reader, which is located 20 miles away from the first RF reader. If the second RF reader detects that the first vehicle is traveling above 100 mph, then the second RF reader may communicate with the local police department communication device, using an emergency frequency. The local police department communication device may be a police radio in a police car or police office.

In FIG. 6, the processor 33 determines the communication characteristics as a function of location of the RF reader 30 or satellite communication signal, broadcast signals (e.g., TV or radio station signals). In this example, the RF reader 30 includes a sensor 32, such as a GPS device, that determines the current location of the RF Reader 30. The GPS device communicates with the Communication Device 3, which may be a GPS satellite, to determine the location of the RF reader 30. The processor 33 determines whether the current location is in Geographical Zone 1 and/or Geographical Zone 2. The geographical zones are associated with one or more communication characteristics for one or more RF tags and/or one or more communication devices. Accordingly, if the RF reader 30 is in Geographical Zone 1, then the RF reader 30 determines that the RF Tag 1's communication characteristics include Frequency GZ1 and Protocol GZ1, and Communication Device 1's communication characteristics include Frequency CD1 and Protocol CD1. If the RF reader 30 is in Geographical Zone 2, then the RF reader 30 determines that the RF Tag 2's communication characteristics include Frequency GZ2 and Protocol GZ2, and Communication Device 2's communication characteristics include Frequency CD2 and Protocol CD2. Alternatively, past or future locations may be used. For example, the next destination of a trip may be used.

In alternative embodiments, location markers, the landscape, the weather, signs, or environment characteristics may be used to determine one or more communication characteristics. For example, a first frequency may be used when it is raining, and a second frequency may be used when it is snowing. The first frequency and the second frequency may be the same or different. In another example, a first protocol stack may be used when the RF reader is above a certain elevation, and a second protocol stack may be used when the RF reader is below the certain elevation.

The RF reader 30 may continuously or periodically determine communication characteristics for the RF device 20 and/or communication device 40. Accordingly, the RF reader 30 may detect a change in communication characteristics. For example, as shown in FIG. 3, the RF reader 30 may detect a change from RF Tag 1's communication characteristics (e.g., [Frequency 1, Protocol 1]) to RF Tag 2's communication characteristics (e.g., [Frequency 2, Protocol]). In another example, as shown in FIG. 4, the RF reader 30 detects when the current time transitions from Time Period 1 to Time Period 2. In yet another example, as shown in FIG. 5, the RF reader 30 detects when the RF reader 30 transitions from Geographical Zone 1 to Geographical Zone 2.

The processor 33 may configure the RF reader 30 to communicate using the determined communication characteristics. Configuring the RF reader 30 may include the adjustment of hardware, software, firmware, documentation, or any combination thereof. For example, analog and/or digital circuits may be configured or reconfigured to communicate using the determined communication characteristics. In another example, software is configured to switch one portion of the communication characteristics (e.g., protocol), and hardware (e.g., an antenna) is configured to switch another portion of the communication characteristics (e.g., frequency).

The processor 33 may determine an efficient configuration for configuring the RF reader 30. As used herein, “an efficient configuration” is a configuration of hardware and software that maximizes or minimizes one or more of the RF reader's resources, such as power. For example, the hardware and/or software components of the RF reader 30, which are used to communicate using the determined communication characteristics, are powered up; whereas, the non-needed components are powered down or turned off. The efficient configuration may be used to configure the RF reader 30. In one embodiment, the efficient configuration may be received from an external communication device.

The processor 33 may cause a signal to be transmitted to the RF device 20 and/or communication device 40. The RF signal may be transmitted using the determined communication characteristics. For example, as shown in FIG. 3, the RF Reader 1 may transmit Response Signal 1 to RF Tag 1 and transmit Response Signal 2 to RF Reader 2. Response Signal 1 may be transmitted at Frequency 1 and using Protocol 1. Response Signal 2 may be transmitted at Frequency 2 and using Protocol 2. Frequency 1 may be the same or different than Frequency 2, and Protocol 1 may be the same or different than Protocol 2. In the illustration above, the RF reader may communicate with the first RF tag at 433 MHz and using a passenger protocol. However, the RF reader transmits an RF signal at 915 MHz and using a shipment protocol to the second RF tag. The RF Reader 1 may be configured to communicate with the Communication Device 1, using the communication characteristics of Communication Device 1. The RF Reader 1 may be configured to communicate with the Communication Device 2, using the communication characteristics of Communication Device 2.

The processor 33 is operable to authenticate communication with the RF tag or RF tag configuration. Authentication may include verifying, confirming, or checking security. The processor 33 may authenticate any communication received or identified by the RF tag. The processor 23 may also authenticate a configuration. As an example of authentication, the processor 33 is operable to authenticate an RF device (e.g., using login identification, password, codes, keys), software (e.g., waveforms, protocols, bitfiles, firmware, algorithms, applications, device drivers), hardware (e.g., sensors, actuators, antennas), configuration of internal circuits (e.g., analog, digital), interconnects and devices, modules, peripherals within the RF tag. Authentication information may be sent with initial query/request. This would provide a mode so that the RF tag does not respond with any signal at all if the initial request does not come from an authenticated source.

The processor 33 communicates with memory 34. Communication may include reading, writing, storing, retrieving, requesting, or a combination thereof. For example, the processor 33 may store sensor information, transducer information, or signal requirements in the memory 34. The processor 33 may retrieve the stored information. The retrieved information may be used, for example, to determine communication characteristics.

The memory 24 is computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media and the like. The memory 24 may be a single device or a combination of devices. The memory 24 may be adjacent to, part of, networked with and/or remote from the processor 23.

The memory 34 may store information. For example, the memory 24 may store sensor information, transducer information, communication characteristics, associations, or communication requirements. The memory 34 may provide the stored information to the processor 33. For example, the information may be read from the memory 24.

Logic may be encoded in one or more tangible media (e.g., memory 34) for execution. As used herein, logic encoded in one or more tangible media is defined as instructions that are executable by a programmed processor and that are provided on computer-readable storage media, memories, or a combination thereof. For example, the memory 34 may store data representing instructions executable by the processor 33. The processor 23 is programmed with and executes the instructions. The functions, processes, acts, methods or tasks illustrated in the figures or described herein are performed by the programmed processor 23 executing the instructions stored in the memory 24. The functions, acts, processes, methods or tasks are independent of the particular type of instructions set, storage media, processor, or processing strategy and may be performed by software, hardware, integrated circuits, firm ware, micro-code and the like, operating alone or in combination.

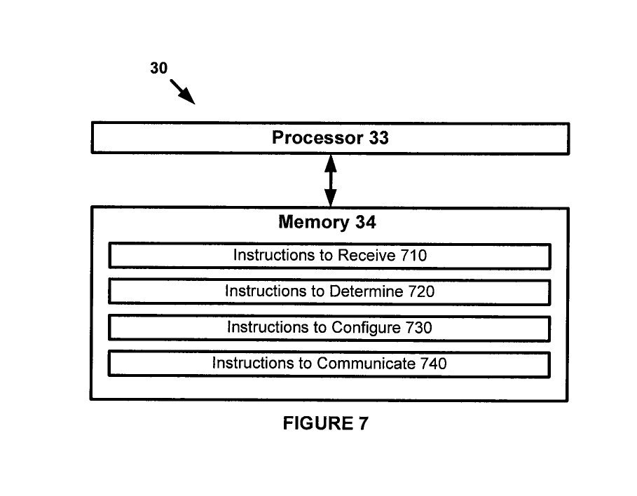

FIG. 7 shows one embodiment of an RF Tag 20 with a programmed processor 23 and memory 24 storing data representing instructions, which are executable by the processor 23. As shown in FIG. 7, the memory 24 includes instructions to receive 710, instructions to determine 720, instructions to configure 730, and instructions to communicate 740. In alternative embodiments, additional, different, or fewer instructions may be provided. For example, instructions for authenticating queries may be provided.

As shown in FIG. 7, the instructions to receive 710 are executed to actively or passively receive, for example, transducer information, sensor information, communication from a communication device, or a combination thereof. The instructions to determine 720 are executed to determine one or more communication characteristics or one or more sets of communication characteristics for one or more RF readers 30, and/or one or more communication devices 40. The one or more communication characteristics may be determined as a function of the transducer information, sensor information, communication from a communication device, or a combination thereof. The instructions to configure 730 are executed to configure the RF reader 30, such that the RF reader 30 is operable to communicate with an RF device 20, which is communicating using one or more of the determined communication characteristics, and/or a communication device 40, which is communicating using one or more of the determined communication characteristics. Configuration may include configuring hardware, software, or the combination thereof. The configuration may be a complete configuration or a partial configuration. The instructions to communicate 740 may be executed to communicate with an RF device 20, which is using the one or more communication characteristics. The instructions to communicate 740 may be executed to transmit and receive communication signals, such as RF signals. Since the RF reader 30 is configured to communicate using the communication characteristics, the RF reader 30 may receive communication signals in compliance with the communication characteristics used by the RF device 20 and/or communication device 40.

The communication device 40 is a radio, personal computer, server, network device, dispatch system, remote memory store, personal digital assistant, cellular device, or any other device for communicating with the RF reader 30. In one embodiment, RF reader 30 includes the communication device 40. A user may use the communication device 40 to view or control communication received from or transmitted to the RF reader 30. In the illustration above, the police radio is the communication device 40.

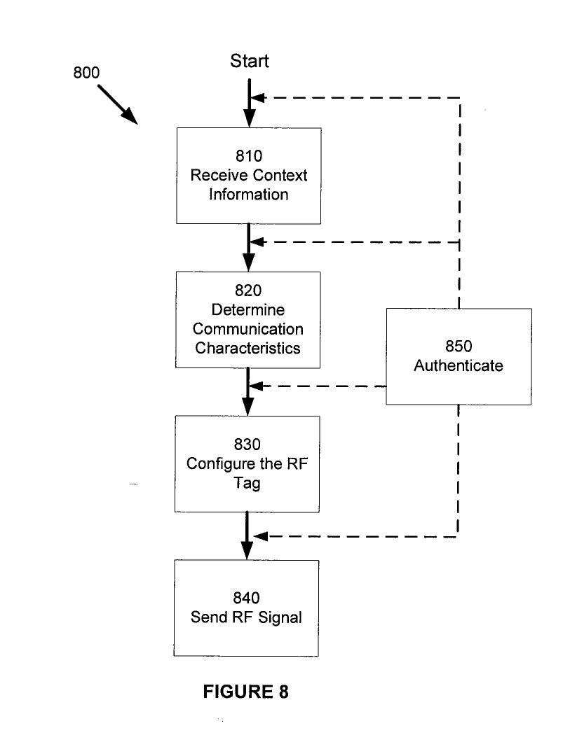

FIG. 8 shows a method 800 for configuring an RF Reader. The method 800 is implemented using the system 100 of FIG. 1 or a different system. The acts may be performed in the order shown or a different order. For example, act 850 may be performed before or after act 810, act 820, act 830, or act 840. The acts may be performed automatically, manually, or the combination thereof.

The method 800 may include receiving context information [act 810]; determining communication characteristics for one or more RF devices [act 820]; configuring the RF reader [act 830]; and sending a signal [act 840]. In alternative embodiments, additional, different, or fewer acts may be provided. For example, act 810 and act 850 do not need to be performed. In another example, the method 800 may include displaying and/or storing sensor information, transducer information, or communication characteristics.

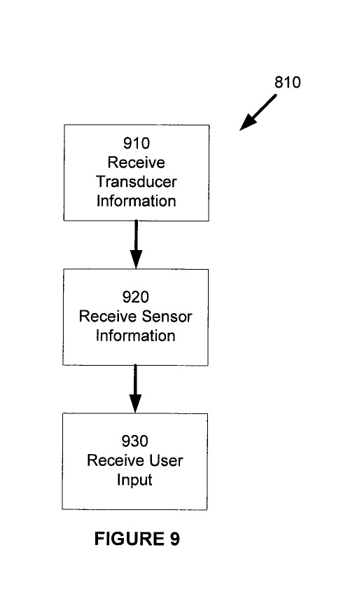

In act 810, an RF reader receives context information. FIG. 9 shows one embodiment of receiving context information.

In FIG. 9, the RF reader receives transducer information using a transducer in act 910. As used herein, “receiving” may include identifying, reading, obtaining, collecting, retrieving, or requesting. The transducer information may be information received via the transducer. The transducer is operable to receive information that may be converted into an electrical signal. The information to be converted and/or the electrical signal may be transducer information. In one example, the transducer receives an incoming communication signal from an RF device and/or a communication device. The incoming communication signal is transducer information. In act 920, the RF reader receives sensor information using a sensor. The sensor information is information received via the sensor. In act 930, the RF reader receives user input information. The user input information is information provided by a user.

In FIG. 8, the RF reader determines communication characteristics for one or more RF devices and/or one or more communication device in act 820. As used herein, determining may include signal processing, reading, associating, calculating, or approximating. In act 830, the RF reader is configured to communicate using communication characteristics. Configuring the RF reader may include configuring hardware, software, or the combination thereof. The RF reader may be configured to communicate using an efficient setting. In act 840, the RF reader communicates with an RF device and/or communication device using the determined communication characteristics. Communication may include transmitting, receiving, or the combination thereof. For example, the RF reader may transmit sensor information to the RF tag using the communication characteristics.

In one embodiment, as shown in FIG. 8, the RF reader authenticates one or more of the acts or components in act 850. The authentication may take place at any stage of the method shown in FIG. 8. The authentication may authenticate communication transmitted to or being transmitted by the RF reader. For example, authentication may include validating everything that “touches” or communicates with the RF tag.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A radio frequency (RF) reader, comprising:
a memory; and
a processor in communication with the memory, the memory including computer code executable by the processor, wherein the computer code is configured to:
determine a first communication characteristic for a first device coupled with the RF reader, the first device being operable to communicate with the first device using the first communication characteristic;
determine a first reader configuration that is operable to communicate using the first communication characteristic;
determine a second communication characteristic for a second device coupled with the RF reader, the second device being operable to communicate with the second device using the second communication characteristic;
determine a second reader configuration that is operable to communicate using the second communication characteristic; and
configure the RF reader to communicate with the first device using the first reader configuration and the second device using the second reader configuration.

2. The RF reader as claimed in claim 1, wherein the first device and second device are RF tags, communication devices, or a combination thereof.

3. The RF reader as claimed in claim 1, wherein the first communication characteristic includes a first protocol and the second communication characteristic includes a second protocol, the first protocol being different than the second protocol.

4. The RF reader as claimed in claim 1, wherein switching the RF reader configuration includes configuring RF reader hardware and RF reader software.

5. The RF reader as claimed in claim 1, wherein the first configuration is different than the second configuration.

6. The RF reader as claimed in claim 1, wherein to determine the first communication characteristic, the computer code is configured to process a first communication signal transmitted from a RF device or communication device to determine the first communication characteristic.

7. The RF reader as claimed in claim 1, wherein to determine the first communication characteristic, the computer code is configured to determine the first communication characteristic and the second communication characteristic from a communication characteristic database stored in the memory.

8. The RF reader as claimed in claim 1, wherein the RF reader configuration is dynamically switched between the first reader configuration and the second reader configuration.

9. Logic encoded in one or more tangible media for execution and when executed operable to cause a RF reader to:
determine a first reader configuration for the RF reader, such that the RF reader is operable to communicate with a first RF tag;
determine a second reader configuration for the RF reader, such that the RF reader is operable to communicate with a second RF tag;
select one of a first reader configuration or a second reader configuration; and
configure the RF reader using the selected first reader configuration or selected second reader configuration.

10. The logic of claim 9, wherein the first reader configuration is used to communicate using a first protocol and the second reader configuration is used to communicate using a second protocol.

11. The logic of claim 9, wherein the first reader configuration is different than the second reader configuration.

12. The logic of claim 9, when executed also operable to cause the RF reader to dynamically switch between the selected configuration and a non-selected configuration.

13. The logic of claim 12, when executed also operable to cause the RF reader to determine a third reader configuration for the RF reader, such that the RF reader is operable to communicate with a first communication device, wherein selection includes selecting a first reader configuration, a second reader configuration, or a third reader configuration.

14. The logic of claim 9, when executed also operable to cause the RF reader to dynamically switch between the first reader configuration, the second reader configuration, and the third reader configuration.

15. A method for configuring a radio frequency (RF) reader, the method comprising:
configuring the RF reader to communicate with a first RF tag coupled with the RF reader, the RF tag using a first communication characteristic to communicate with the RF reader;
receiving a first communication signal from the RF tag, the first communication signal being transmitted using a first communication characteristic, the first communication signal including RF tag information;
configuring the RF reader to communicate with a first communication device coupled with the RF reader, the first communication device using a second communication characteristic to communicate with the RF reader;
transmitting the RF tag information to the first communication device using the second communication characteristic.

16. The method as claimed in claim 15, wherein configuring the RF reader includes configuring hardware and software.

17. The method as claimed in claim 16, wherein configuring hardware includes lengthening or shortening an antenna.

18. The method as claimed in claim 15, comprising sensing a sensed condition using a sensor, the sensed condition being used to determine a first communication characteristic or a second communication characteristic.

19. The method as claimed in claim 15, wherein the first communication characteristic includes a first protocol and a first frequency and the second communication characteristic includes a second protocol and a second frequency.

20. The method as claimed in claim 15, wherein the first protocol is different than the second protocol and the first frequency is different than the second frequency.
